(19) United States
(12) Patent Application Publication
(10) Pub. No.: US 2026/0078604 A1
(43) Pub. Date: Mar. 19, 2026

(54) PORTABLE SHELTER LIGHTING SYSTEM

(71) Applicant: INSTANT PROMOTION INC., Raleigh, NC (US)

(72) Inventor: Jordan Law, Raleigh, NC (US)

(21) Appl. No.: 19/330,943

(22) Filed: Sep. 17, 2025

Related U.S. Application Data
(60) Provisional application No. 63/696,517, filed on Sep. 19, 2024.

(51) Int. Cl. E04H 15/10; F21S 4/28; F21V 23/00; F21V 23/04

(52) U.S. Cl. CPC E04H 15/10; F21S 4/28; F21V 23/003; F21V 23/0442

(57) ABSTRACT

A portable shelter lighting system including a plurality of light emitting diodes (LEDs) positioned within a central pole of a portable shelter. The portable shelter lighting system is designed to illuminate a portable shelter in an expanded configuration. The portable shelter lighting system controls the intensity and color of the light generated by the plurality of light emitting diodes.

### CROSS-REFERENCE TO RELATED APPLICATIONS

This application claims priority to and the benefit of U.S. Provisional Ser. No. 63/696,517 filed on Sep. 19, 2024, the entire contents of which is incorporated by reference in its entirety.

### BACKGROUND

Many travelers (e.g., campers, hikers) must carry a portable lighting source because current portable shelters (e.g., tents) do not have integrated light generating components. This increases the burden on travelers. Additionally, travelers can forget the portable lighting source, thereby limiting the traveler's visibility. Therefore, there is a need for a portable shelter that includes an integrated lighting system to reduce the burden on travelers.

### FIELD OF THE DISCLOSURE

The present disclosure is generally directed to lighting systems, more specifically to integrated lighting systems for portable shelters.

### DESCRIPTION OF RELATED ART

Current portable shelters (e.g., tents) fail to include built-in lighting systems. This results in travelers packing separate lighting systems. Some of these lighting systems can attach (e.g., clip) to the portable shelters, however, the separate lighting systems are not designed to match the size and shape of each portable shelter. This can result in poor attachment and/or poor illumination of the portable shelter.

Current clip-on lighting systems fail to illuminate the entirety of the interior of a portable shelter because the lighting system is not evenly distributed. Additionally, many of these lighting systems are positioned at eye level which can harm a person's eyes as they enter into a tent. Further, tents typically include a metal central pole that provides the main structural support for the tent. Disadvantageously, these metal poles do not allow light to shine through, so any lighting systems must be external to the metal central pole. Therefore, there is a need for a portable shelter including an integrated lighting system positioned in a central pole that provides 360-degree lighting.

### BRIEF SUMMARY

In some aspects of the present disclosure, a portable shelter lighting system is disclosed. The portable shelter lighting system can be positioned inside a portable shelter. The portable shelter includes a pop-up tent including a clear central pole. The portable shelter lighting system is positioned within the clear central pole and is operable to illuminate the pop-up tent. Advantageously, the portable shelter lighting system is operable to provide 360 degrees of light inside the pop-up tent. In some aspects, a power switch is positioned at a bottom of the central pole. In some embodiments, the portable shelter lighting system further includes a dimmer switch. In some embodiments, the portable shelter lighting system is further operable for changing the color and intensity of the light generated by a plurality of light emitting diodes.

In some embodiments, the portable shelter lighting system includes a power supply, a processor, and a plurality of light generating components. In some embodiments, the plurality of light generating components is positioned in a central pole of a corresponding portable shelter. Advantageously, the plurality of light generating components is operable to illuminate the entire portable shelter. In an aspect, the power supply includes a removable battery, a rechargeable battery, or a non-rechargeable battery. In some embodiments, the power supply includes a 12-volt battery. In some embodiments, the power supply is operable to generate 110 volts of power.

In some embodiments, the portable shelter lighting system includes a rigid bar including a plurality of light emitting diodes. In some embodiments, the plurality of light emitting diodes is positioned on a flexible strip. In some embodiments, the portable shelter lighting system includes a chip-on-board (CoB) LED component. For example, and without limitation, the CoB LED component includes a plurality of LED chips mounted on a thermal substrate. The portable shelter lighting system includes a power supply for providing energy to drive the CoB LED component.

### BRIEF DESCRIPTION OF THE SEVERAL VIEWS OF THE DRAWINGS

The embodiments illustrated, described, and discussed herein are illustrative of the present disclosure. As these embodiments of the present disclosure are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present disclosure, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

FIG. 1 illustrates a portable shelter lighting system according to at least one aspect of the present disclosure.

FIG. 2 illustrates an exploded view of a portable shelter lighting system according to at least one aspect of the present disclosure.

FIG. 3A illustrates an LED subassembly of a portable shelter lighting system according to at least one aspect of the present disclosure.

FIG. 3B illustrates an LED subassembly of a portable shelter lighting system according to at least one aspect of the present disclosure.

FIG. 3C illustrates an LED subassembly of a portable shelter lighting system according to at least one aspect of the present disclosure.

FIG. 4A illustrates an LED strip according to at least one aspect of the present disclosure.

FIG. 4B illustrates the LED strip of FIG. 4A along line A-A.

FIG. 5 illustrates an exploded view of a control housing according to at least one aspect of the present disclosure.

FIG. 6A illustrates a push switch of a portable shelter lighting system according to at least one aspect of the present disclosure.

FIG. 6B illustrates a push switch of a portable shelter lighting system according to at least one aspect of the present disclosure.

FIG. 6C illustrates a push switch of a portable shelter lighting system according to at least one aspect of the present disclosure.

FIG. 7A illustrates a dimmer PCB of a portable shelter lighting system according to at least one aspect of the present disclosure.

FIG. 7B illustrates a dimmer PCB of a portable shelter lighting system according to at least one aspect of the present disclosure.

FIG. 7C illustrates a dimmer PCB of a portable shelter lighting system according to at least one aspect of the present disclosure.

FIG. 7D illustrates a dimmer PCB of a portable shelter lighting system according to at least one aspect of the present disclosure.

FIG. 7E illustrates a dimmer PCB of a portable shelter lighting system according to at least one aspect of the present disclosure.

FIG. 8A illustrates a power patch cord of a portable shelter lighting system according to at least one aspect of the present disclosure.

FIG. 8B illustrates a power patch cord of a portable shelter lighting system according to at least one aspect of the present disclosure.

FIG. 9A illustrates a DC jack of a portable shelter lighting system according to at least one aspect of the present disclosure.

FIG. 9B illustrates a DC jack of a portable shelter lighting system according to at least one aspect of the present disclosure.

FIG. 10 illustrates a circuitry diagram of a portable shelter lighting system according to one embodiment of the present disclosure.

FIG. 11 illustrates a portable shelter lighting system according to at least one aspect of the present disclosure.

FIG. 12 illustrates a portable shelter lighting system according to at least one aspect of the present disclosure.

FIG. 13 illustrates a portable shelter lighting system according to at least one aspect of the present disclosure.

FIG. 14 illustrates a portable shelter lighting system according to at least one aspect of the present disclosure.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device”can include a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the presently disclosed subject matter.

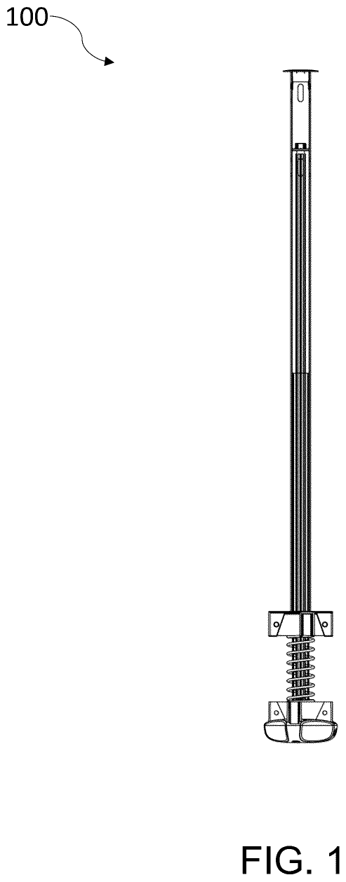

FIG. 1 illustrates a portable shelter lighting system 100 of a portable shelter according to at least one aspect of the present disclosure. In at least one aspect of the present disclosure, the portable shelter lighting system 100 is removably attached or fixedly attached to a portable shelter. The portable shelter may include temporary, semi-permanent, or permanent structures. For example, and without limitation, the portable shelter can include a marquee, a gazebo, a tent, a canopy, a canopy tent, an exhibition booth, a pop up booth, a market stall, and other similar structures.

The portable shelter lighting system is configured to provide customizable lighting for illuminating a corresponding shelter. Advantageously, this enables users to generate and control lighting for various events (e.g., hiking, concerts). For example, and without limitation, the portable shelter lighting system can provide 360 degrees of lighting that fully illuminates a shelter. In at least one aspect of the present disclosure, the portable shelter lighting system is configured to modify a lighting output between 0% to 100%. For example, and without limitation, the portable shelter lighting system may include a dimmer positioned on a bottom surface of the portable shelter lighting system. The dimmer is configured to adjust the lighting output based on a desired characteristic. The portable shelter lighting system can be further configured to adjust additional lighting characteristics, including but not limited to color, hue, saturation, temperature, and brightness.

In some aspects, the portable shelter lighting system is configured for wireless or wired communication with one or more other portable shelter lighting systems. Advantageously, this enables synchronization of lighting output between multiple portable shelter lighting systems. For example, and without limitation, multiple portable shelter lighting systems can be configured to adjust (automatically or manually) lighting output based on environmental conditions, a schedule, and combinations thereof. For example, the portable shelter lighting system may include at least one sensor designed to detect the amount of sunlight. When the amount of sunlight drops below a designated threshold, the portable shelter lighting system can automatically increase or decrease the lighting output based on user preference. The portable shelter lighting system can further generate an alert to a corresponding remote device. The alert may indicate that the user conditions (e.g., low sunlight) are met and provide a prompt to confirm a change in a lighting output. Advantageously, this enables users to adjust the lighting output based on their preference. In at least one aspect, a plurality of portable shelter lighting systems may be coupled via a single power adapter. Advantageously, this enables power control over multiple portable shelter lighting systems via a single source, which is helpful in remote environments that have limited power sources.

In at least one aspect of the present disclosure, the portable shelter lighting system can generate and monitor a geofence corresponding to a predetermined area relative to the portable shelter lighting system. For example, and without limitation, the portable shelter lighting system may be configured to generate a virtual geofence around a boundary of the portable shelter lighting system. The portable shelter lighting system is configured to generate an alert and/or modify a lighting parameter based on a geofence trigger. For example, and without limitation, the portable shelter lighting system can automatically activate a plurality of LEDs based on detection of an individual entering the geofence. The portable shelter lighting system can further deactivate the plurality of LEDs when an individual leaves the geofence. Advantageously, this provides autonomous control of the lighting output of the portable shelter lighting system.

In at least one aspect of the present disclosure, the portable shelter lighting system includes at least one sensor. The at least one sensor can include a motion sensor, a lighting sensor, a temperature sensor, a humidity sensor, a voice sensor, a wind sensor, or other similar sensors. The portable shelter lighting system is configured to receive, collect, and send sensor data. The portable shelter lighting system is configured to generate alerts and automatically update the generated light based on the sensor data. For example, and without limitation, the portable shelter lighting system may detect that the temperature in a portable shelter is over a designated threshold and generate an alert or modify a lighting color (e.g., red) to indicate an issue corresponding to the temperature.

In at least one aspect of the present disclosure, the portable shelter lighting system is configured for color temperature control, an audio system, a fire/smoke detection system, a texture central pole, flashing functionality for emergencies, and a red night vision mode. In at least one aspect of the present disclosure, the portable shelter lighting system is configured for motion detection and corresponding lighting adjustments. The portable shelter lighting system may further include geofencing triggers, and security control. The portable shelter lighting system can be remotely controlled (e.g., via a mobile application).

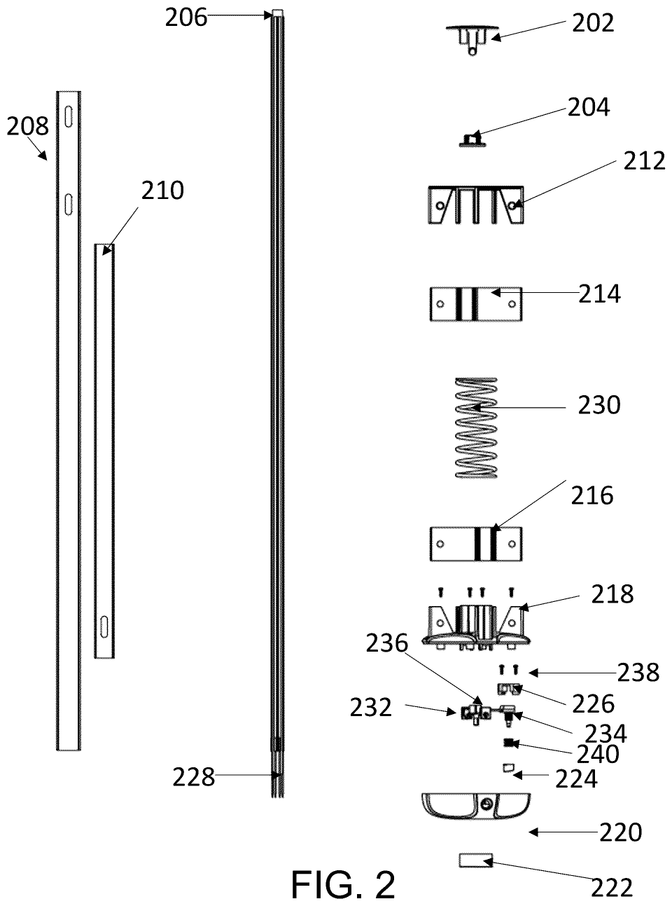

FIG. 2 illustrates an exploded view of a portable shelter lighting system according to at least one aspect of the present disclosure. The central pole 200 includes a cap (e.g., acrylonitrile butadiene styrene (ABS) plastic) 202, an LED stabilizer 204, an LED extrusion 206, an outer extrusion 208, an inner extrusion 210, a bracket cover 212, a first bracket 214, a second bracket 216, a control housing top 218, a control housing bottom 220, a control housing rotary knob 222, a control housing power button 224, a power button retention bracket 226, a COB LED strip 228, a spring 230, a dimmer PCB 232, a power switch 234, a DC barrel jack 236, a plurality of screw 238, and a compression spring 240.

In at least one aspect of the present disclosure, the central pole is bolted to the portable shelter frame. In at least one aspect, the central pole is removably attached to a portable shelter frame. The extrusions (206, 208, 210) are positioned within the central pole 200. The central pole can include a plurality of COB LED strips (e.g., 228) positioned on each side of the LED extrusion 206. Advantageously, positioning a LED strip on each side of the LED extrusion enables the portable shelter lighting system to provide 360 degrees of lighting without repositioning of the LEDs. The LED stabilizer 204 is configured to regulate voltage to the COB LED strips.

The power switch 234 and the dimmer are positioned on a bottom surface of the central pole 200. The power switch 234 may include a push on-push off switch that enables a user to activate and deactivate the portable shelter lighting system by pressing the power switch 234. The dimmer is in electric communication with the COB LED strip. The dimmer can adjust a lighting output (e.g., between 0% to 100%) of the portable shelter lighting system. In at least one aspect of the present disclosure, the LED dimmer is a rotatable switch positioned on a bottom surface of the central pole. The LED dimmer is configured to rotate in circular manner, which corresponds to the lighting output of the central pole. In at least one aspect of the present disclosure, the power switch and the dimmer include a visual indicator (e.g., light). In at least one aspect of the present disclosure, the portable shelter lighting system includes a displayer interface for indicating a power level and/or power consumption of the portable shelter lighting system. In at least one aspect, the portable shelter lighting system includes a removable battery pack. In at least one aspect of the present disclosure, the portable shelter lighting system is configured for solar charging.

In at least one aspect of the present disclosure, the portable shelter lighting system includes a plurality of cables (e.g., patch cables) for connecting to one or more central poles of other portable shelter lighting systems. Advantageously, this enables the at least two central poles to operate off a single power adapter. In at least one aspect of the present disclosure, the power adapter is configured for 72 watts. In at least one aspect the power adapter is configured for at least three central poles and 180 watts.

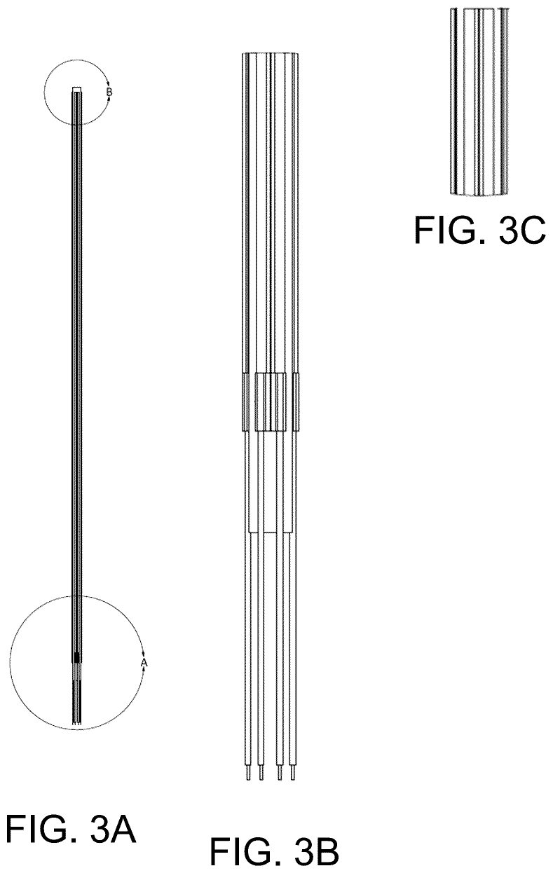

FIG. 3A illustrates a side view of an LED subassembly according to at least one assembly of the present disclosure. FIG. 3B illustrates a view of the LED subassembly along line A-A of FIG. 3A. FIG. 3C illustrates a view of the LED subassembly along the line B-B of FIG. 3A. In at least one aspect of the present disclosure, the plurality of COB LED strips are bonded via aluminum extrusion. The COB LED strips are further configured for a press fit onto the main housing.

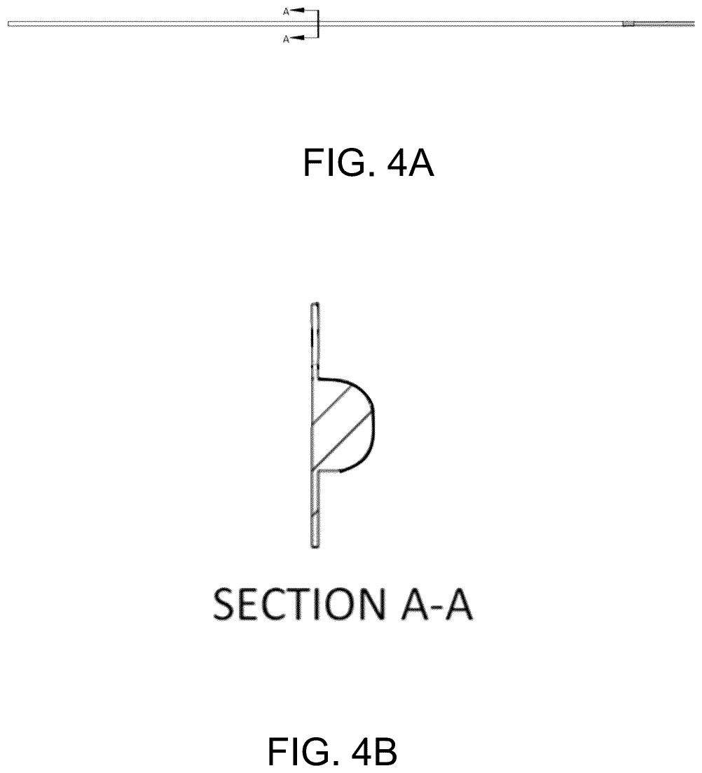

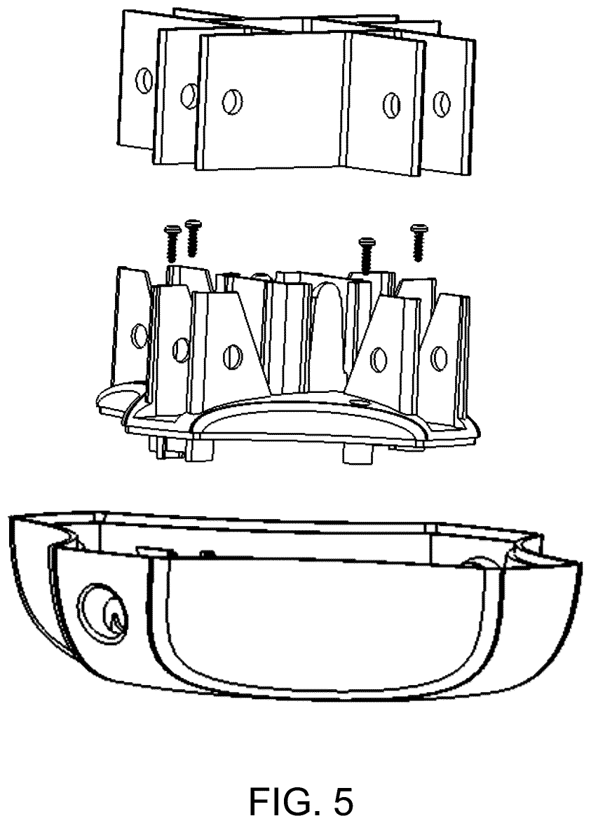

FIG. 4A illustrates an LED strip according to at least one aspect of the present disclosure. FIG. 4B illustrates a side view of the LED strip shown in FIG. 4A. In at least one aspect of the present disclosure, the LED strip is configured for 12 Volts or 24 Volts. FIG. 5 illustrates an exploded view of a control housing according to at least one aspect of the present disclosure. The control housing is configured to attach with the LED subassembly and the plurality of LED extrusions.

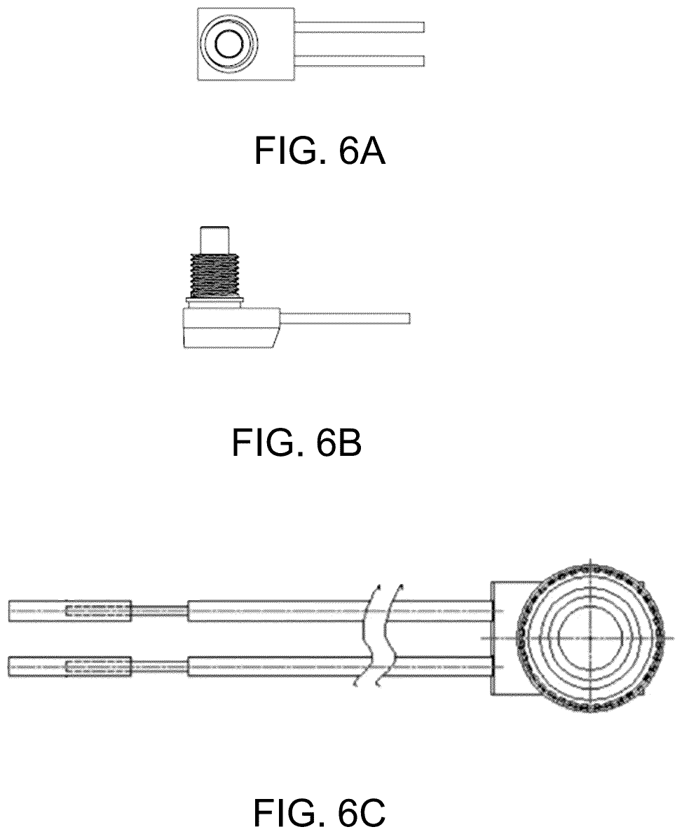

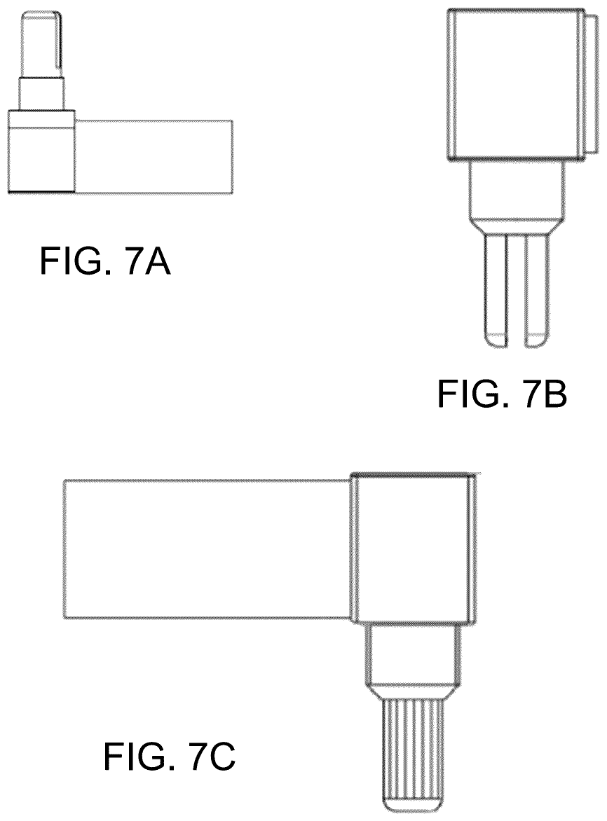

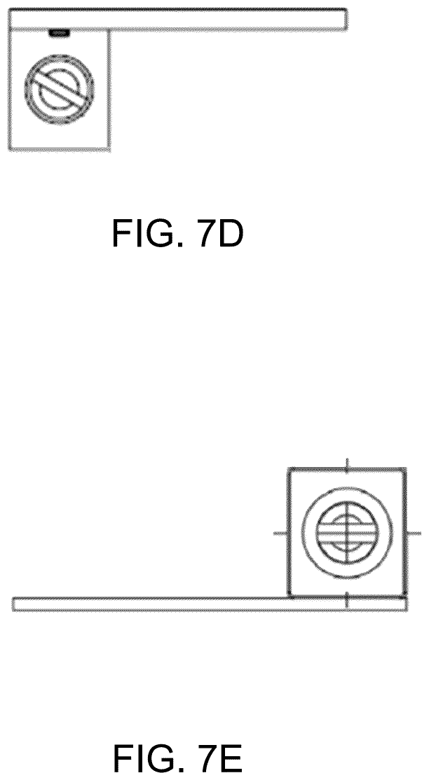

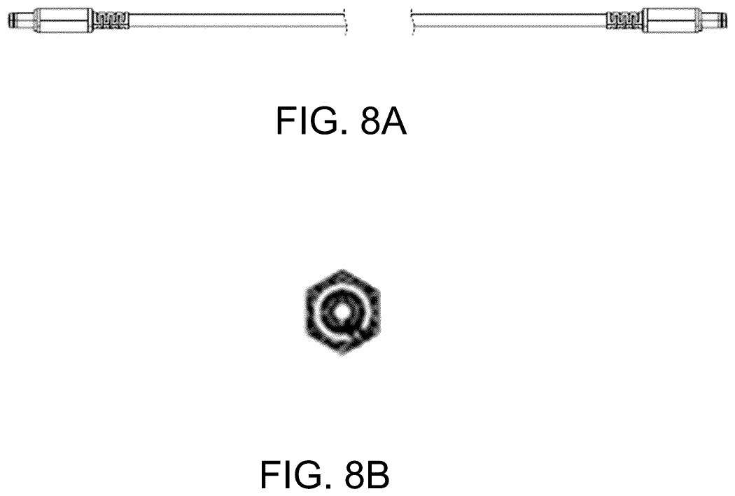

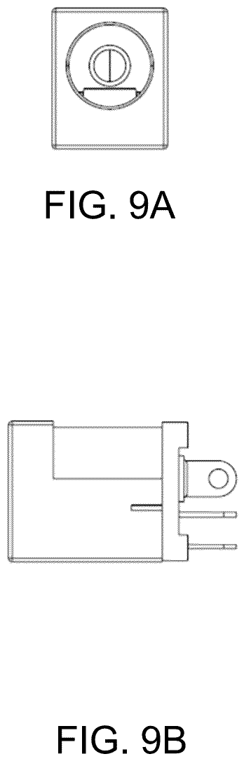

FIG. 6A illustrates a push-button switch of a portable shelter lighting system according to at least one aspect of the present disclosure. FIG. 6B illustrates a push-button switch of a portable shelter lighting system according to at least one aspect of the present disclosure. FIG. 6C illustrates a push-button switch of a portable shelter lighting system according to at least one aspect of the present disclosure. FIGS. 7A-7E illustrate a dimmer PCB according to at least one aspect of the present disclosure. FIG. 8A illustrates a power cord according to at least one aspect of the present disclosure.

In at least one aspect of the present disclosure, the power switch is configured for a voltage of about 120 Volts, a current of about 3 amperes, a wire diameter of about 18 AWG, and a dust rating of IP65. The power switch is configured to toggle between an on and off position. In at least one aspect of the present disclosure, the COB LED strip is configured for a voltage of about 24 VDC, a power of about 8 Watts, a length of about 1.1 meters, a dust rating of IP54, and a color rating of 8000 k. In at least one aspect of the present disclosure, the LED dimmer is configured for a voltage between about 3.7 VDC to about 24 VDC, and a current up to 4 amperes. The LED dimmer is configured to dim the LED strips. In at least one aspect of the present disclosure, the DC power jack is configured for a voltage of 48 VDC and a current up to 7.5 amperes. In at least one aspect of the present disclosure, the power patch cord is configured for a voltage of about 24 VDC, a current of 6 amperes, and a wire diameter of 18 AWG. The power patch cord is configured to connect up to three lights using one power adapter.

In at least one aspect of the present disclosure, the portable shelter lighting system includes a central pole, a support frame, and a cover. The portable shelter lighting system includes an LED array positioned within the central pole. The LED array includes plurality of lighting emitting diodes, an LED chip, a power supply component, controllable electronics, and a housing. Advantageously, the portable shelter lighting system is integrated into a portable shelter, therefore the portable shelter lighting system does not need to be attached or detached during setup or takedown of the corresponding portable shelter.

In some embodiments, the portable shelter lighting system includes an LED driver, power component (e.g., switch, button), setting controls, and at least one indicator. The LED driver includes control electronics configured to control the light outputted by the portable shelter lighting system. In some embodiments, the control electronics includes a current regulator and a dimming control circuit. In some embodiments, the portable shelter lighting system is controlled via a power component (e.g., switch, button) positioned on a bottom of the central pole. Advantageously, this enables a user to activate or deactivate the portable shelter lighting system from inside the portable shelter. In some embodiments, the portable shelter lighting system further includes a dimmer component (e.g., switch, dial) positioned on or near a bottom of the central pole. Advantageously, this enables a user to control the intensity of light generated by the portable shelter lighting system. In some embodiments, the portable shelter lighting system includes at least one battery. For example, and without limitation, the at least one battery include a renewable battery. Alternatively, or additionally, the at least one battery includes a non-renewable battery. In some embodiments, the at least one battery includes a solar power storage component (e.g., solar battery).

In some embodiments, the portable shelter lighting system includes a multicolor, dimmable LED array. The LED array is customizable based on user preferences. In some embodiments, the portable shelter lighting system includes a printed circuit board assembly including a light generating component. In some embodiments, the light generating component is operable to generate a color (e.g., blue, green). In some embodiments, the portable shelter lighting system includes a plurality of rechargeable batteries. Alternatively, or additionally, the portable shelter lighting system includes a solar power module designed to power the LED array using a solar cell.

In some embodiments, the portable shelter lighting system includes control electronics including a processor. The processor manages the overall operations of the portable shelter lighting system. The processor is any controller, microcontroller, or microprocessor that is capable of processing program instructions. In one embodiment, the control electronics includes at least one antenna, which enables the portable shelter lighting system to send information (e.g., brightness) to at least one remote device (e.g., smartphone, tablet, laptop computer) and/or receive information (e.g., lighting intensity) from at least one remote device. The at least one antenna provides wireless communication, standards-based or non-standards-based, by way of example and not limitation, radiofrequency (RF), BLUETOOTH, ZIGBEE, NEAR FIELD COMMUNICATION (NFC), or other similar communication methods.

In at least one aspect of the present disclosure, the portable shelter lighting system includes a plurality of LED arrays attached to one or more supports of portable shelter (e.g., tent). For example, and without limitation, the plurality of LED arrays is removably attached to a corresponding support member. For example, and without limitation, the plurality of LED arrays is attached to a corresponding support member utilizing at least one fastener (e.g., bolt, bracket). Alternatively, the plurality of LED arrays is integrated into the support frame of the portable shelter and is non-removable from a corresponding support member. The corresponding support member is affixed to a bottom bracket of a central pole.

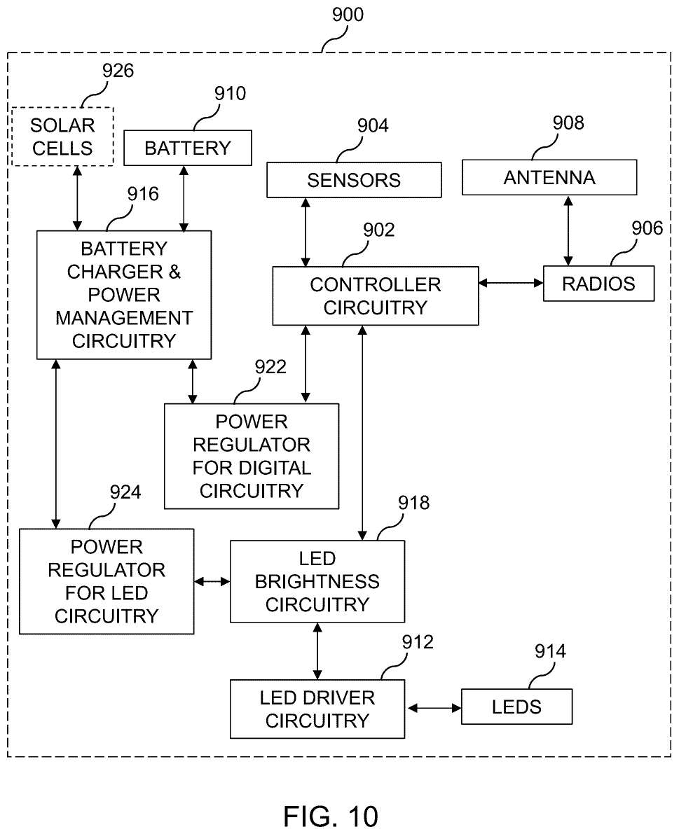

FIG. 10 depicts a circuitry 900 of a portable shelter lighting system according to one embodiment of the present disclosure. The block diagram includes controller circuitry 902 electrically coupled with sensors 904, and radios 906. The radios 906 may include DASH7 technologies, Zigbee technologies, Bluetooth technologies, Wi-Fi, Sigfox, DSRC, low-power wide area network (WAN) technologies, and/or the like. The low-power WAN technologies may include LoRaWAN technologies. The radios 906 are electrically coupled to at least one antenna 908.

The controller circuitry 902 is also electrically coupled with LED brightness circuitry 918. The LED brightness circuitry is electrically coupled with LED drive circuitry 912. The LED drive circuitry 912 is electrically coupled with a plurality of LEDs 914. The block diagram also includes a battery charger and power management circuitry 916. The solar cells 926 and the battery 910 are electrically coupled with the battery charger and power management circuitry 916. A power regulator 922 (for digital circuitry) is electrically coupled between the battery charger and power management circuitry 916 and the controller circuitry 902. A power regulator 924 (for LED circuitry) is electrically coupled between the LED brightness circuitry 918 and the battery charger and power management circuitry 916.

In some embodiments, the portable shelter lighting system includes a light emitting diode (LED) array with a plurality of mounting holes, a connector port, radial die configuration, and a connector harness. For example, and not limitation, the plurality of mounting holes is used to attach the LED array to the printed circuit board assembly or another component of the portable shelter lighting system. The connector port is operable to receive a male connector of a corresponding cable. The radial die spacing configuration is designed to improve lumen density and beam control. In some embodiments, the LED array includes a heatsink, an adhesive thermal pad, and/or other heat-dissipating component and/or material. In some embodiments, the LED array further includes a lithium polymer battery pack.

In some aspects, the portable shelter lighting system is operable for illuminating a portable shelter including a plurality of support poles. For example, and without limitation, the portable shelter lighting system includes at least one LED array positioned within at least one support pole of the plurality of support poles. Each LED array is independently controllable via a corresponding power switch and/or a remote device. In some embodiments, each LED array is in wired connection (e.g., cable) with at least one other LED array to enable power transfer. Advantageously, the plurality of LED arrays can be synchronized to have matching intensities and colors.

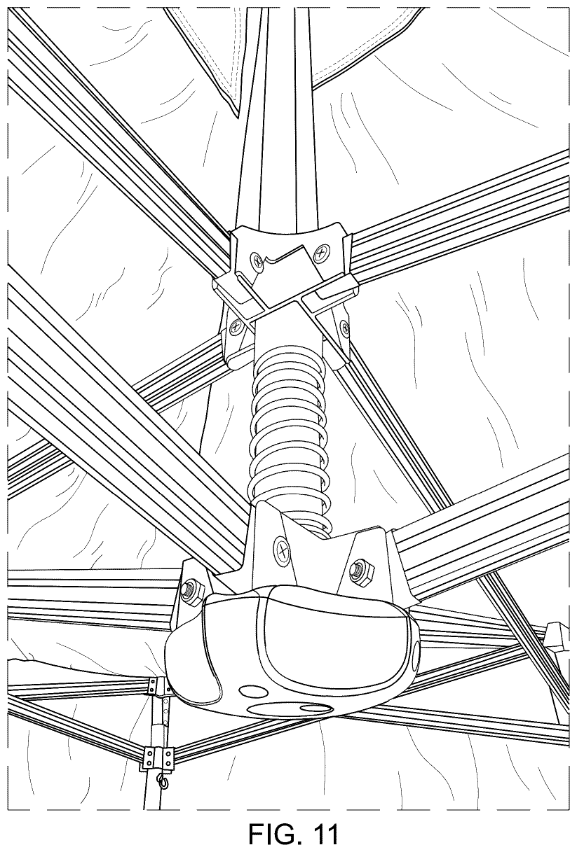

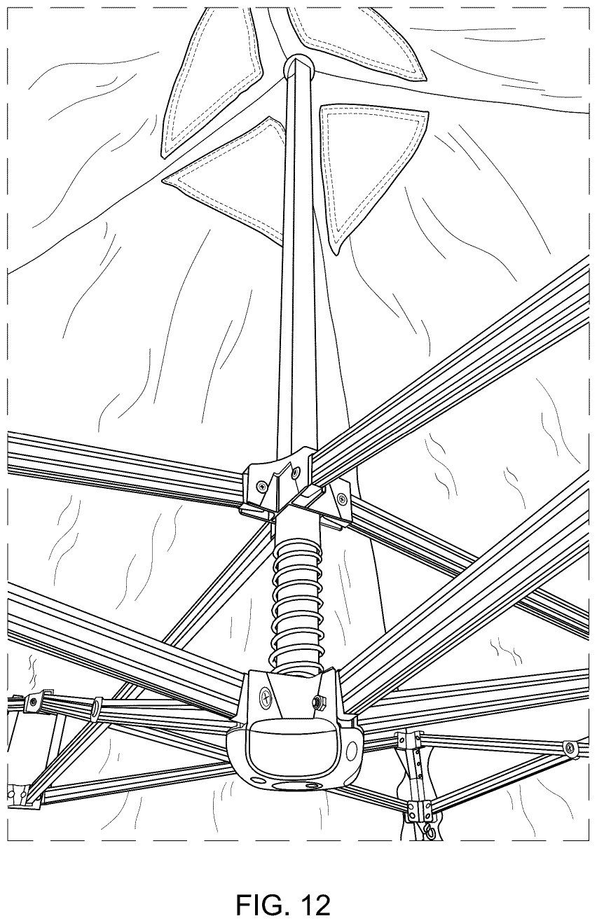

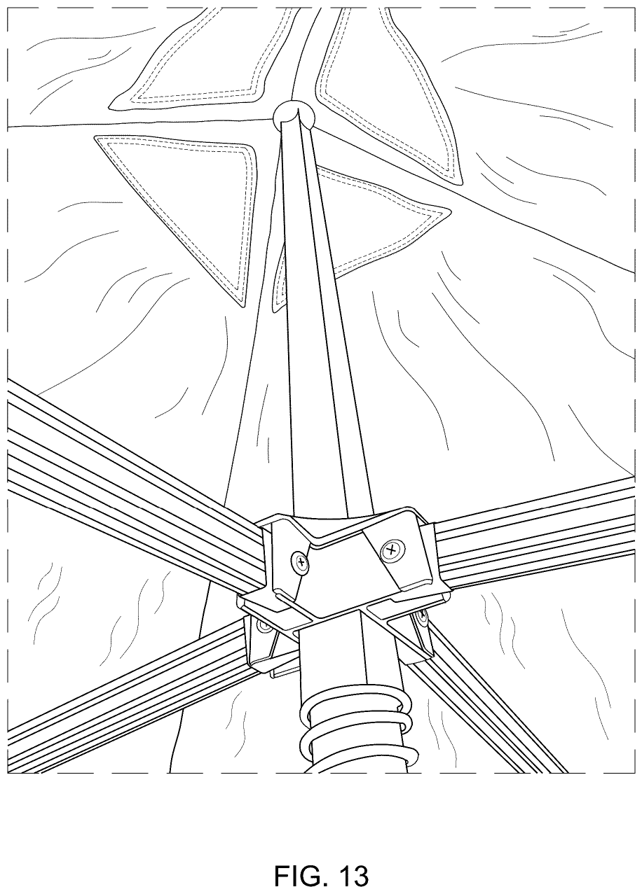

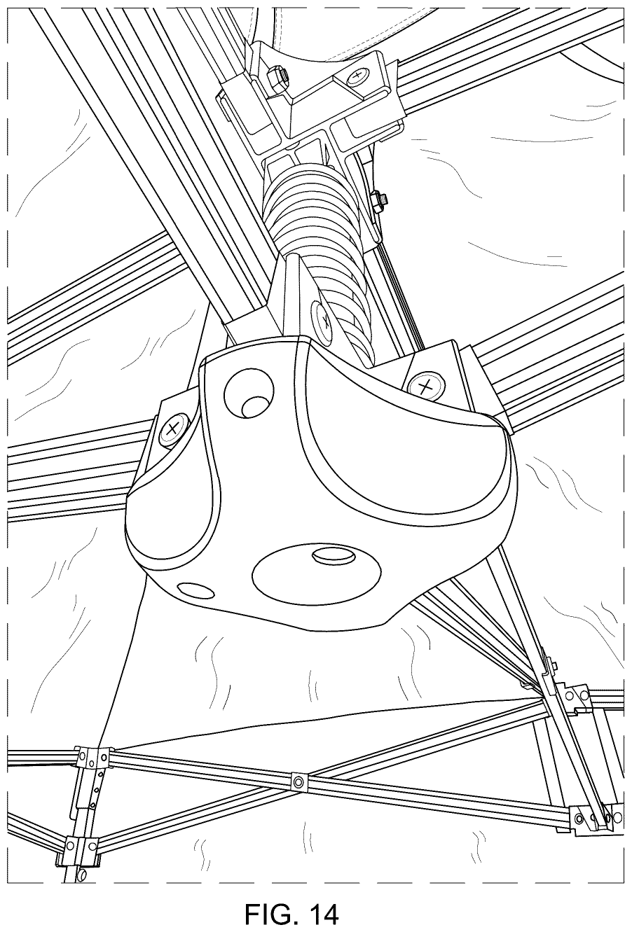

FIGS. 11-14 illustrate a perspective view of a portable shelter lighting system in a shelter according to at least one aspect of the present disclosure. The portable shelter lighting system is configured to provide customizable lighting for illuminating a corresponding shelter. Advantageously, this enables users to generate and control lighting for various events (e.g., hiking, concerts). For example, and without limitation, the portable shelter lighting system can provide 360 degrees of lighting that fully illuminates a shelter. In at least one aspect of the present disclosure, the portable shelter lighting system is configured to modify a lighting output between 0% to 100%. For example, and without limitation, the portable shelter lighting system may include a dimmer positioned on a bottom surface of the portable shelter lighting system. The dimmer is configured to adjust the lighting output based on a desired characteristic. The portable shelter lighting system can be further configured to adjust additional lighting characteristics, including but not limited to color, hue, saturation, temperature, and brightness.

In some aspects, the portable shelter lighting system is configured for wireless or wired communication with one or more other portable shelter lighting systems. Advantageously, this enables synchronization of lighting output between multiple portable shelter lighting systems. For example, and without limitation, multiple portable shelter lighting systems can be configured to adjust (automatically or manually) lighting output based on environmental conditions, a schedule, and combinations thereof. For example, the portable shelter lighting system may include at least one sensor designed to detect the amount of sunlight. When the amount of sunlight drops below a designated threshold, the portable shelter lighting system can automatically increase or decrease the lighting output based on user preference. The portable shelter lighting system can further generate an alert to a corresponding remote device. The alert may indicate that the user conditions (e.g., low sunlight) are met and provide a prompt to confirm a change in a lighting output. Advantageously, this enables users to adjust the lighting output based on their preference. In at least one aspect, a plurality of portable shelter lighting systems may be coupled via a single power adapter. Advantageously, this enables power control over multiple portable shelter lighting systems via a single source, which is helpful in remote environments that have limited power sources.

In at least one aspect of the present disclosure, the portable shelter lighting system can generate and monitor a geofence corresponding to a predetermined area relative to the portable shelter lighting system. For example, and without limitation, the portable shelter lighting system may be configured to generate a virtual geofence around a boundary of the portable shelter lighting system. The portable shelter lighting system is configured to generate an alert and/or modify a lighting parameter based on a geofence trigger. For example, and without limitation, the portable shelter lighting system can automatically activate a plurality of LEDs based on detection of an individual entering the geofence. The portable shelter lighting system can further deactivate the plurality of LEDs when an individual leaves the geofence. Advantageously, this provides autonomous control of the lighting output of the portable shelter lighting system.

In at least one aspect of the present disclosure, the portable shelter lighting system includes at least one sensor. The at least one sensor can include a motion sensor, a lighting sensor, a temperature sensor, a humidity sensor, a voice sensor, a wind sensor, or other similar sensors. The portable shelter lighting system is configured to receive, collect, and send sensor data. The portable shelter lighting system is configured to generate alerts and automatically update the generated light based on the sensor data. For example, and without limitation, the portable shelter lighting system may detect that the temperature in a portable shelter is over a designated threshold and generate an alert or modify a lighting color (e.g., red) to indicate an issue corresponding to the temperature.

In at least one aspect of the present disclosure, the portable shelter lighting system is configured for color temperature control, an audio system, a fire/smoke detection system, a texture central pole, flashing functionality for emergencies, and a red night vision mode. In at least one aspect of the present disclosure, the portable shelter lighting system is configured for motion detection and corresponding lighting adjustments. The portable shelter lighting system may further include geofencing triggers, and security control. The portable shelter lighting system can be remotely controlled (e.g., via a mobile application).

The portable shelter lighting systems shown in FIGS. 11-14 may include a cap (e.g., acrylonitrile butadiene styrene (ABS) plastic), an LED stabilizer, an LED extrusion, an outer extrusion, an inner extrusion, a bracket cover, a first bracket, a second bracket, a control housing top, a control housing bottom, a control housing rotary knob, a control housing power button, a power button retention bracket, a COB LED strip, a spring, a dimmer PCB, a power switch, a DC barrel jack, a plurality of screw, and a compression spring.

The portable shelter lighting system may be bolted to a portable shelter frame. In at least one aspect, the portable shelter lighting system is removably attached to a portable shelter frame. The portable shelter lighting system can include a plurality of COB LED strips positioned on each side of the LED extrusion. Advantageously, positioning a LED strip on each side of the LED extrusion enables the portable shelter lighting system to provide 360 degrees of lighting without repositioning of the LEDs. The LED stabilizer is configured to regulate voltage to the COB LED strips.

The power switch and the dimmer can be positioned on a bottom surface of the portable shelter lighting system. The power switch may include a push on-push off switch that enables a user to activate and deactivate the portable shelter lighting system by pressing the power switch. The dimmer is in electric communication with the COB LED strip. The dimmer can adjust a lighting output (e.g., between 0% to 100%) of the portable shelter lighting system. In at least one aspect of the present disclosure, the LED dimmer is a rotatable switch positioned on a bottom surface of the portable shelter lighting system. The LED dimmer is configured to rotate in circular manner, which corresponds to the lighting output of the central pole. In at least one aspect of the present disclosure, the power switch and the dimmer include a visual indicator (e.g., light). In at least one aspect of the present disclosure, the portable shelter lighting system includes a displayer interface for indicating a power level and/or power consumption of the portable shelter lighting system. In at least one aspect, the portable shelter lighting system includes a removable battery pack. In at least one aspect of the present disclosure, the portable shelter lighting system is configured for solar charging.

In at least one aspect of the present disclosure, the portable shelter lighting system includes a plurality of cables (e.g., patch cables) for connecting to one or more central poles of other portable shelter lighting systems. Advantageously, this enables the at least two central poles to operate off a single power adapter. In at least one aspect of the present disclosure, the power adapter is configured for 72 watts. In at least one aspect the power adapter is configured for at least three central poles and 180 watts.

Particular embodiments and features have been described with reference to the drawings. It is to be understood that these descriptions are not limited to any single embodiment or any particular set of features, and that similar embodiments and features may arise, or modifications and additions may be made without departing from the scope of these descriptions and the spirit of the appended claims.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A portable shelter lighting system comprising:
at least one cover;
a frame comprising a plurality of support members; and
a lighting system;
wherein at least one of the plurality of support members includes a central support member, wherein the lighting system is positioned in or on the central support member;
wherein the lighting system includes a plurality of light emitting diodes (LED) strips, an LED stabilizer, a lighting control housing, and a power switch, wherein each LED strip of the plurality of LED strips includes a plurality of LEDs, and
wherein the lighting system is configured to control the plurality of LED strips.

2. The portable shelter lighting system of claim 1, wherein the central support member is transparent.

3. The portable shelter lighting system of claim 1, wherein the lighting system includes a lighting control system, wherein the lighting control system is configured to control a lighting output of the plurality of LED strips, wherein the lighting control system is configured to control at least one of a lighting intensity, lighting color, lighting hue, and combinations thereof.

4. The portable shelter lighting system of claim 1, wherein the central support member is removably attached to the plurality of support members.

5. The portable shelter lighting system of claim 1, wherein the lighting system is configured to generate 360-degree lighting.

6. The portable shelter lighting system of claim 1, wherein the central support member includes a dimmer positioned on a bottom surface of the central support member, wherein the dimmer is rotatably configured to adjust a lighting output of the lighting system.

7. The portable shelter lighting system of claim 1 further configured for wireless communication, wherein the portable shelter lighting system is configured to receive lighting commands from a remote device, wherein in response to receiving the lighting commands, the portable shelter lighting system is configured to adjust at least one characteristic of a lighting output of the plurality of LED strips.

8. The portable shelter lighting system of claim 1, wherein a top surface of the central support member is attached to the at least one cover.

9. The portable shelter lighting system of claim 1, wherein each LED strip of the plurality of LED strips is positioned on a side of an extrusion, wherein the extrusion is positioned inside the central support member.

10. A portable shelter lighting system comprising:
at least one cover;
a frame comprising a plurality of support members;
a lighting system; and
at least one sensor;
wherein at least one of the plurality of support members includes a central support member, wherein the lighting system is positioned in the central support member;
wherein the at least one sensor is in network communication with the lighting system;
wherein the lighting system includes a plurality of light emitting diode (LED) strips, an LED stabilizer, a lighting control housing, a power switch,
wherein each LED strip of the plurality of LED strips includes a plurality of LEDs; and
wherein the lighting system is configured to control the plurality of LED strips.

11. The portable shelter lighting system of claim 10, wherein the at least one sensor includes an environmental sensor, wherein the environment sensor is configured to detect at least one environmental condition, wherein based on the at least one environmental condition, the lighting system is configured to automatically adjust a characteristic of a lighting output of the plurality of LEDs.

12. The portable shelter lighting system of claim 11, wherein the lighting characteristic includes lighting intensity, lighting color, lighting hue, and combinations thereof.

13. The portable shelter lighting system of claim 11, wherein the at least one environmental condition includes sunlight, wind speed, temperature, or humidity.

14. The portable shelter lighting system of claim 10, wherein each LED strip of the plurality of LED strips is positioned on a side of an extrusion, wherein the extrusion is positioned inside the central support member.

15. The portable shelter lighting system of claim 8, wherein the central support member is transparent.

16. A portable shelter lighting system comprising:
at least one cover;
a frame comprising a plurality of support members;
a lighting system; and
at least one sensor;
wherein at least one of the plurality of support members includes a central support member, wherein the lighting system is positioned in the central support member, wherein a top surface of the central support member is connected to the at least one cover, wherein the central support member includes at least one extrusion;
wherein the at least one sensor is in network communication with the lighting system;
wherein the lighting system includes a plurality of light emitting diode (LED) strips, an LED stabilizer, a lighting control housing, a power switch,
wherein each LED strip of the plurality of LED strips includes a plurality of LEDs;
wherein each LED strip of the plurality of LED strips is positioned on a separate side of the at least one extrusion; and
wherein the lighting system is configured to control the plurality of LED strips.

17. The portable shelter lighting system of claim 16, wherein the central support member is transparent.

18. The portable shelter lighting system of claim 16, wherein the lighting system is configured to generate 360 degrees of lighting.

19. The portable shelter lighting system of claim 16, wherein the at least one sensor includes an environmental sensor, wherein the environment sensor is configured to detect at least one environmental condition, wherein based on the at least one environmental condition, the lighting system is configured to automatically adjust a characteristic of a lighting output of the plurality of LEDs, wherein the lighting characteristic includes lighting intensity, lighting color, lighting hue, and combinations thereof.

20. The portable shelter lighting system of claim 19, wherein the at least one environmental condition includes sunlight, wind speed, temperature, or humidity.
